(19) United States
(12) Patent Application Publication
(10) Pub. No.: US 2005/0284824 A1
(43) Pub. Date: Dec. 29, 2005

(54) Filter cake treatment apparatus and method

(75) Inventors: Richard P. Anderson, Clarendon Hills, IL (US); Donn Armstrong, Downers Grove, IL (US); Lance Jacobsen, Minooka, IL (US)

Correspondence Address: Harry M Levy;Emrich & Dithmar, 125 South Wacker Drive, Suite 2080, Chicago, IL, 60606, US

(73) Assignee: International Titanium Powder, LLC, Lockport, IL (US)

(21) Appl. No.: 10/526,911

(22) PCT Filed: Sep. 3, 2003
(86) PCT No.: PCT/US03/27653

§ 371 Date: Jul. 25, 2005

Related U.S. Application Data
(60) Provisional application No. 60/408,920, filed on Sep. 7, 2002.
(60) Provisional application No. 60/408,824, filed on Sep. 7, 2002.
(60) Provisional application No. 60/408,952, filed on Sep. 7, 2002.

(51) Int. Cl. B01D 37/00

(52) U.S. Cl. 210/768

(57) ABSTRACT

A method of separating metal particulates form a slurry of liquid metal and metal particulates and salt particulates by filtering the slurry to form a cake of metal and salt particulates with some liquid metal. The cake is broken and liquid metal is removed by vacuum distillation or with a hot inert sweep gas at either positon or negative pressure from the broken cake, and thereafter separating the metal and salt particulates. Thereafter, the metal partucilates are sized before water washing to prevent unacceptable explosions upon contact with water.

### RELATED APPLICATIONS

This application, pursuant to 37 C.F.R. 1.78(c), claims priority based on provisional application Ser. No. 60/408,920, filed Sep. 7, 2002, U.S. Provisional Application Ser. No. 60/408,824, filed Sep. 7, 2002 and U.S. Provisional Application Ser. No. 60/408,952, filed Sep. 7, 2002

### BACKGROUND OF THE INVENTION

This invention relates to the Armstrong process as described in U.S. Pat. Nos. 5,779,761, 5,958,106 and 6,409,797, the disclosures of each of which is incorporated herein by reference. In the production of a metal or alloy or other elemental material as described in the above-referenced patents, a slurry is produced which if filtered provides a filter cake in the form of a gel. The slurry has a solids fraction which depends in large part on the amount of excess reductant metal used to control the steady-state temperatures at which the reaction runs. As liquid metal drains through the filter to build the filter cake, a gel is formed from which particles do not settle, unless the gel is broken, such as by mechanical disturbance or other means. The gel when formed includes the metal particles formed during the reduction, the salt particles formed during the reduction and interstitial liquid metal. The liquid metal in the gel has to be removed by way of distillation with or without a vacuum or by contact with a hot sweep gas, preferably inert to the constituents of the gel with or without a vacuum or any combination thereof.

### SUMMARY OF THE INVENTION

In the specific example of the patents, liquid sodium is used as a reducing metal, and titanium tetrachloride as the source of the halide vapor to produce titanium powder. However, this invention pertains to any product produced by the Armstrong Process. The gel, therefore in this specific example, is liquid sodium, salt (NaCl) particles and titanium powder or particulates.

In one instance of treatment of the filter cake and gel, vacuum distillation of the filter cake typically results in an initial temperature rise in the cake which thereafter holds constant and a constant pressure for a long period of time, such as about 40,000 seconds (about 11 hours) to about 50,000 seconds (about 14 hours), at current typical temperatures and pressures of about 550° C. and about 50 millitorr. Thereafter, there is a long tail of decreasing temperature and pressure, also about 40,000 seconds (about 11 hours) to about 50,000 seconds (about 14 hours) to distill sufficient sodium from the gel until the gel is ready for additional processing. Accordingly, the first portion of the distill may take between about 11 and 14 hours and the same for the tail portion of the distill. It is understood by those of ordinary skill in the art that distillation of the tail may not be able completely to remove all the liquid metal trapped in the interstices of the metal powder and salt, so that some very small amount of liquid sodium may remain even after the distill shows that no more liquid metal is being distilled.

A series of graphs attached hereto show the relationship between pressure and time as well as a partial cross-sectional view of the filter trap showing the cake and the mechanism for distilling sodium.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1 is a graph of pressure rise versus time for a flat plate filter nutsche runs;

FIG. 2 shows data for various temperatures as a function of time and pressure;

FIG. 3 shows a schematic of the filter trap for the above example; and

FIG. 4 shows a schematic of another embodiment of the filter trap of FIG. 3.

### DESCRIPTION OF THE PREFERRED EMBODIMENT

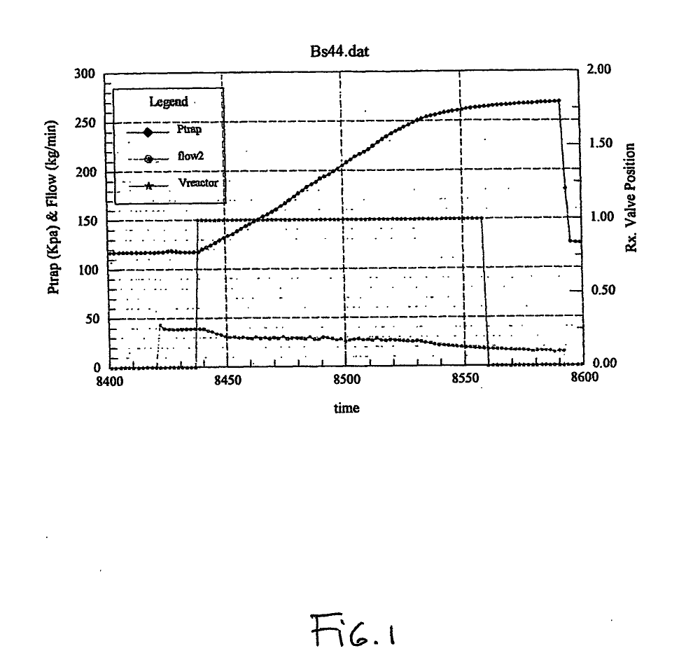

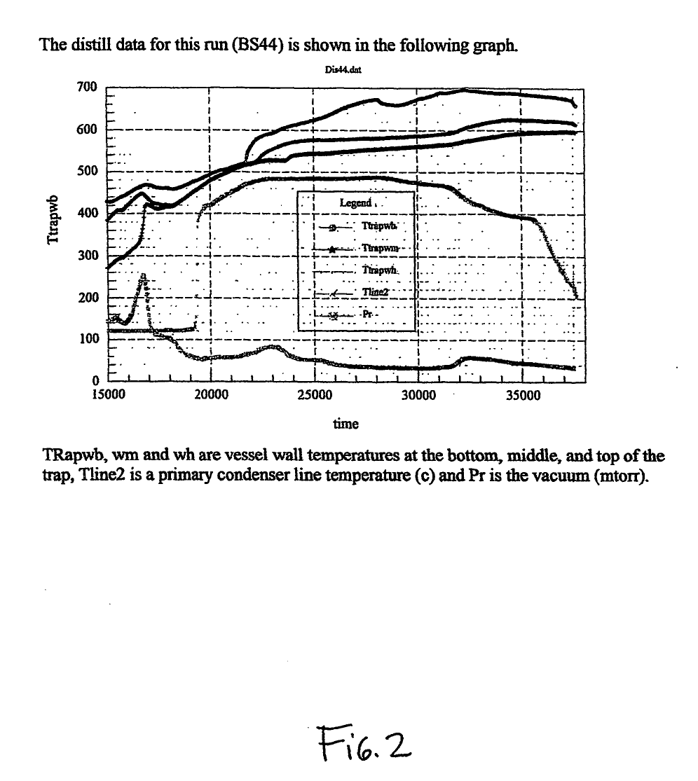

P-trap is the pressure above the filter (assume downstream pressure remains constant) as the run progressed. Flow 2 is the Na flow rate and the V reactor shows when the product was made. At t=8420, sodium flow was initiated to the trap. Trap pressure remained relatively constant as the Na flowed through the clean filter (125 micron) until the reactor valve was opened and started to build cake. The cake DP grew in a linear fashion until t=8520 when the reaction rate began to slow because of nozzle plugging due to subsonic operation of the nozzle. The cake thickness after distillation was measured to be on average 5 to 6 inches. The bottom of the cake appeared less dense than the top of the cake and measurements of the cake density showed a density in the top of the cake of 1.1 g/cc and in the bottom of the cake 0.73 g/cc. It is believed that the bottom was less dense because it was formed at a lower pressure. For example, the DP is determined by the flow rate; for this run the flow rate was 30 kg/min. Also, after product production was terminated and Na flow continued, the cake appeared to compact further (see pressure increase while flow decreased after t=8550). Prior to Na flow shutdown, DP was up to 22 psig versus 18 psig when significant product production ended, see FIGS. 1 and 2.

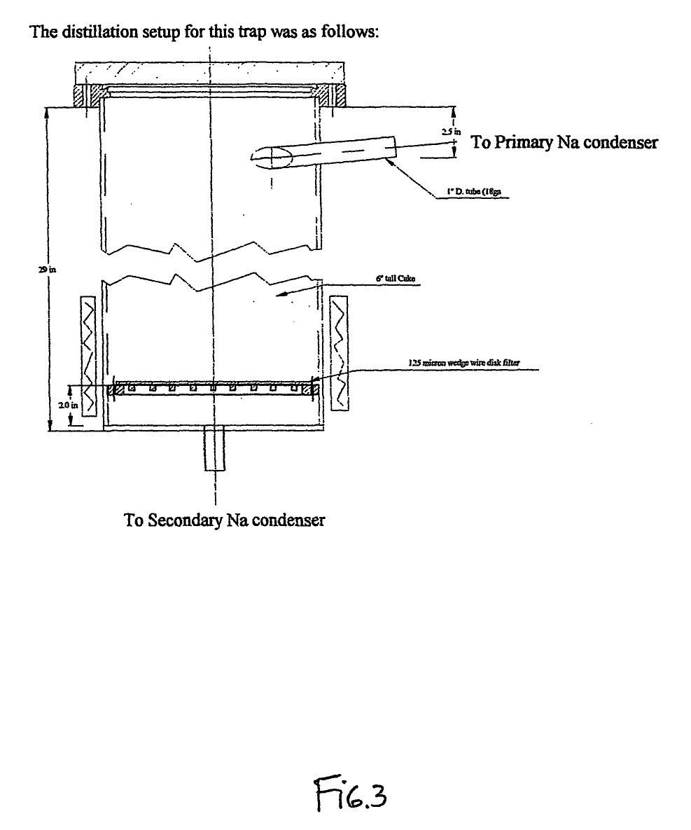

Heat was applied to the cake area and vapor was removed to a primary condenser out the top side of the trap and to a secondary condenser by distilling through the wedge wire filter. During the distillation, a total of 5.9 kg of Na was removed from the cake which weighed 3.4 kg after the distill. 3.8 Kg of the 5.9 kg was found to have condensed in the secondary condenser, see FIG. 3.

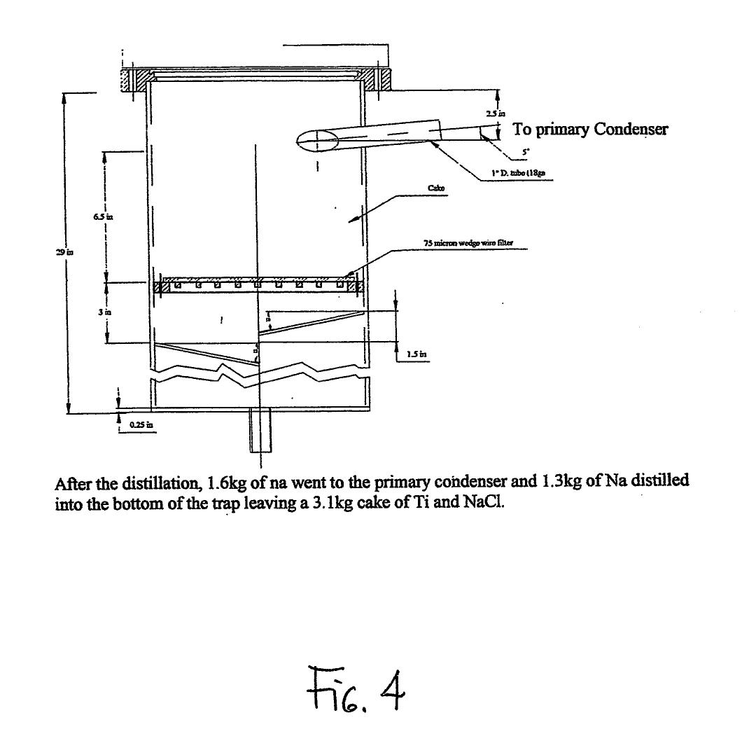

In another nutsche run, the trap was designed to allow distillation through the filter into the bottom of the trap to utilize the full trap diameter for vapor movement. The trap also had the standard 1″ line to a primary condenser, see FIG. 4. Heat was concentrated on the cake area while the bottom of the trap was maintained cool to support condensation of the Na. After distillation, 1.6 kg of Na went to the primary condenser and 1.3 kg. of Na distilled into the bottom of the trap leaving a 3.1 kg. cake of titanium and NaCl.

However, it has been found that breaking the filter cake drastically reduces the distillation times and rates for the distillation of the liquid metal, such as sodium. Using a breaker bar or some other mechanical means such as moving fingers or a mixer has significantly reduced the first portion of the vacuum distill from 40,000-50,000 seconds (11-14 hours) to 20,000 to 30,000 (between about 6 and 8 hours). The second portion of the distill, that is the decreasing temperature and pressure portion referred to as the tail was not affected by breaking the filter cake.

It has also been discovered that using a sweep of inert gas such as argon heated, preferably in the range of from about 500° C. to about 800° C. during the second distill or tail portion reduced the amount of time necessary to distill the reductant metal (sodium) from about 40,000-50,000 seconds to about 10,000 seconds (about 3 hours.). This is a significant improvement over the prior method. By using either one of the methods or a combination of breaking the filter cake combined with an inert gas sweep, the distillation times can be decreased from about (22 or 28) hours to about (9 to 11) hours. This is of significant importance in the design of plants by simplifying designs, reducing collection tanks, valves, piping and other associated equipment. After vacuum distillation is apparently complete, any remaining trapped reductant metal (sodium) becomes impractical to remove. While it seems obvious to introduce the filter cake into water to wash the residual salt (NaCl) from the titanium powder, the problem exists of trapped reductant metal (sodium) in the filter cake which when combined with water could produce a significant explosion. It is a fact that the mixture of sodium liquid and water will provide an explosion having energy greater than the equivalent amount of TNT.

It has been found in the production of Ti by the subsurface reduction of TiCl₄ by Na that crumbling the filter cake into small quantities, such as less than about five centimeters in diameter and preferably in the range of from about two to about five centimeters in diameter, during or subsequent to the distillation of sodium apparently makes particles or clumps small enough that any trapped Na is manageable without significant damage to equipment or harm to personnel, if proper care is taken in equipment design and with appropriate safety precautions. After distillation, the filter cake is friable and easily crumbled. To the extent that large quantities of crumbled filter cake can be water washed without fear of explosion significantly reduces the distillation times required in the production of the various elemental material and alloys described in the above-referenced patents, particularly where sodium or other alkaline metal is used as a reductant.

Alternatively, it has been found that the entire distillation can be accomplished at positive pressure, such as, but not limited to, psig with a heated or hot inert gas, such as but not limited to Ar at about 500° C. to about 800° C. followed by cooling to condense the vaporized liquid metal, such as but not limited to Na. Thereafter, the cooled liquid metal will be returned for additional use.

Summarizing this invention relates to mechanism and methods for decreasing the distillation time of a filter cake produced by the process described in the above-referenced patents. The filter cake can be broken such as by vibration or moving mechanism in the filter cake area or by stationery mechanical bars or members in the filter cake area or other suitable mechanism. An inert sweep gas with or without vacuum can be used alone or in combination with the above described methods breaking the filter cake during the distillation in order significantly to reduce the distillation time of the liquid metal in the filter cake.

While there has been disclosed what is considered to be the preferred embodiment of the present invention, it is understood that various changes in the details may be made without departing from the spirit, or sacrificing any of the advantages of the present invention.

1. A method of separating metal particulates from a slurry of liquid metal and metal particulates and salt particulates, comprising filtering the slurry to form a cake of metal and salt particulates with some liquid metal, breaking the cake and removing liquid metal from the broken cake, and thereafter separating the metal and salt particulates.

2. The method of claim 1, wherein the liquid metal is removed from the broken cake by vacuum distillation.

3. The method of claim 1, wherein the liquid metal is removed from the broken cake with a hot sweep gas.

4. The method of claim 3, wherein the hot sweep gas is an inert gas.

5. The method of claim 4, wherein the inert gas is argon.

6. The method of claim 4, wherein the hot sweep gas is at positive pressure.

7. The method of claim 5, wherein the hot argon sweep gas is at positive pressure.

8. The method of claim 1, wherein the liquid metal is present in the filter cake up to about ten times the weight of the metal particulates.

9. The method of claim 1, wherein the liquid metal is an alkali metal or an alkaline earth metal or mixtures thereof.

10. The method of claim 1, wherein the liquid metal is Na or Mg.

11. The method of claim 1, wherein the metal particulates are Ti.

12. The method of claim 1, wherein the metal particulates are a Ti alloy.

13. The method of claim 1, wherein the salt particulates are a halide.

14. The method of claim 1, wherein the salt particulates are a chloride.

15. The method of claim 1, wherein the metal particulates are Ti or a Ti alloy and the salt is Na or Mg chloride.

16. The method of claim 15, wherein the liquid metal is Na and the salt particulates are NaCl.

17. The method of claim 1, wherein the cake is broken into pieces having diameters up to about five centimeters.

18. The method of claim 1, wherein the cake is broken into pieces having diameters up to about two centimeters.

19. A method of separating metal particulates from a slurry of liquid metal and metal particulates and salt particulates, comprising filtering the slurry to form a cake of metal and salt particulates with some liquid metal, breaking the cake and removing liquid metal from the broken cake, separating the metal and salt particulates, and sizing the metal particulates before water washing to prevent unacceptable explosions upon contact with water.

20. The method of claim 19, wherein the liquid metal is removed from the broken cake by vacuum distillation or by a hot sweep gas.

21. The method of claim 20, wherein the hot sweep gas is argon.

22. The method of claim 20, wherein the hot sweep gas is at positive pressure.

23. The method of claim 21, wherein the hot argon sweep gas is at positive pressure.

24. The method of claim 20, wherein the liquid metal is Na or Mg and is present in the filter cake up to about ten times the weight of metal particulates.

25. The method of claim 24, wherein the metal particulates are Ti or a Ti alloy.

26. The method of claim 25, wherein the cake is broken into pieces having diameters up to about five centimeters.

27. The method of claim 26, wherein the cake is broken into pieces having diameters up to about two centimeters.
